(19) United States
(12) Patent Application Publication
(10) Pub. No.: US 2002/0075361 A1
(43) Pub. Date: Jun. 20, 2002

(54) Ink jet recording head and fabrication method of the same

(75) Inventors: Torahiko Kanda, Tokyo (JP); Kenichi Ohno, Tokyo (JP); Masahiko Sekimoto, Kashiwazaki-shi (JP)

Correspondence Address: Norman P. Soloway, HAYES, SOLOWAY, HENNESSEY,, GROSSMAN & HAGE, P.C., 175 Canal Street, Manchester, NH, 03101, US

(73) Assignee: NEC Corporation

(21) Appl. No.: 10/021,542

(22) Filed: Dec. 12, 2001

(30) Foreign Application Priority Data
Dec. 20, 2000 (JP) 387464/2000

(51) Int. Cl. B41J 2/05

(52) U.S. Cl. 347/65

(57) ABSTRACT

A portion of an ink jet recording head, which is formed by silicon material of a silicon substrate, is used as nozzles, ink chambers and a portion of an ink supply passage for supplying ink to the ink chambers and the remaining ink supply passage is formed of other material than the silicon material and connected to the portion of the ink jet recording head formed of the silicon material. A plurality of ink jet recording heads are formed as a unit block by a semiconductor fabrication process and cut out from a silicon substrate in block unit.

### BACKGROUND OF THE INVENTION

1. Field of the Invention

The present invention relates to an ink jet type recording head for performing an image recording, etc., by jetting ink droplets to a recording medium and a fabrication method for fabricating the same ink jet recording head.

2. Description of the Related Art

It has been required that an ink jet type recording head is capable of finely displaying an image, is compact and has precisely defined gap between adjacent nozzles.

On European Patent Application No. 01 107 047.1, U.S. patent application Ser. No. 09/813,010 and their priority Japanese Patent Applications No. 2000-78871, No. 2000-78953 and No. 2000-307049, we have proposed an ink jet recording head, each of which is fabricated by forming, in a silicon substrate, nozzles for jetting ink, ink chambers connected to the nozzles for pressurize inks filling the ink chambers, branch ink pools for supplying ink to the respective ink chambers, a main ink pool connected to the respective branch ink pools for supplying ink thereto from an ink tank and an ink supply port connected to the ink tank and dicing the silicon substrate. Further, on the above applications, we have proposed a structure of an ink jet recording head in which nozzles and ink chambers are arranged in a line and column matrix and line directions of the nozzles and the chambers are slightly slanted with respect to a printing direction.

Further more, JP H04-148936 A discloses an ink jet recording head having a structure fabricated by cutting it out from a silicon substrate in which a plurality of ink jet recording heads having right and left rows of nozzles and right and left rows of ink chambers are arranged in slightly deviated positions.

In such conventional ink jet recording head fabricated by cutting out from a silicon substrate in which a plurality of ink jet recording heads are formed by utilizing a semiconductor fabricating process, it is possible to make the ink jet recording head compact and to machine it with high precision. Therefore, high quality recording can be done thereby. On the other hand, it has been requested to fabricate an ink jet recording head at a cost as low as possible with yield as high as possible.

Assuming, for example, that size of a unit block, which is composed of two of a plurality of ink jet recording heads arranged in same direction, each of which includes nozzles, ink chambers, branch ink pools, a main ink pool and an ink supply port connected to a common ink tank, as shown in FIG. 10, is a 2 cm×3 cm parallelogram, the number of unit blocks, which can be fabricated from a wafer having diameter of 4 inches, is only 6. Therefore, the cost of an ink jet recording head, which is fabricated from a silicon substrate, is still high.

For example, in a case where a ink jet recording head is fabricated by photo etching a silicon substrate, there is portions of the silicon substrate in which probability of defective ink jet recording heads formed therein become high for a reason based on a fabrication process. In such case, if the number of ink jet recording heads capable of being formed on one wafer is small, a total number of acceptable ink jet recording heads becomes small. On the other hand, if it is possible to obtain a larger number of ink jet recording heads from one wafer, it is possible to substantially reduce a ratio of defective ink jet recording head to thereby improve the yield, so that the fabrication cost of ink jet recording head can be reduced.

In a multi color printer, which has been used practically, at least four color inks, C (cyan), M (magenta), Y (yellow) and black inks, are used and, therefore, the nozzle pitch becomes very small. As a result, the positioning operation of heads of a multi-color printer has to be performed with high precision. Since, when there is a positional deviation between, particularly, C, M and Y color heads, an image quality is substantially influenced thereby, it is necessary to eliminate the positional deviation between ink jet recording heads of these colors. In order to eliminate the positional deviation, the ink jet recording heads of these colors must be arranged in parallel and mounted without positional deviation between them. However, this operation becomes more difficult with reduction of diameter of each nozzle and pitch of the nozzles.

### SUMMARY OF THE INVENTION

The present invention has an object to provide an inexpensive ink jet recording head and a fabrication method thereof with which a large number of ink jet recording heads can be obtained from one wafer.

Another object of the present invention is to provide an ink jet recording head for a multi color printer, which can eliminate mutual positional deviation of ink jet recording heads and allow the multi color printer to perform a fine and high quality multi color printing, and a fabrication method thereof.

In order to increase nozzle density to thereby realize a fine printing, ink jet recording heads are formed in a silicon substrate by utilizing the photo etching technology. What is required to be fabricated with high precision is a construction including nozzles and ink chambers. Further, branch ink pool paths for supplying ink to the respective ink chambers arranged in matrix require high precision machining in micron unit since they are provided adjacent to the ink chambers.

Although the branch ink pool paths for supplying ink to the ink chambers are fabricated with high precision since they are provided adjacent to the ink chambers, machining preciseness required for a main ink pool path connected to the branch ink pool paths to supply ink to a plurality of the branch ink pool paths and an ink supply port connected to an ink supply path from an ink tank is lower than that of the nozzles, the ink chambers and the branch ink pool paths, since the volumes of the main ink pool path and the ink supply port are larger than the volume of the branch ink pool paths.

The present inventors had paid an attention to this fact and have been found that the number of ink jet recording heads obtainable from one wafer can be increased and the yield can be improved by forming the main ink pool path and the ink supply port of a synthetic resin or a metal material and adhering them to each silicon head member cut out from the silicon substrate in which the ink chambers and the branch ink pool paths are formed, without influence on a recording density of the ink jet recording head.

That is, according to an aspect of the present invention, an ink jet recording head includes nozzles for jetting ink, ink chambers formed in communication with the nozzles and pressuring ink filling therein, an ink supply path for supplying ink to the ink chambers and a pressure generating mechanism for generating pressure in ink in the ink chambers, wherein at least the ink chambers and a portion of the ink supply path are formed in a crystalline plate and the other portion of the ink supply path is formed of a material other than that of the crystalline plate and connected to the portion of the ink supply path formed in the crystalline plate.

In this case, the other portion of the ink supply path formed by the material other than a material of the crystal plate may constitute the main ink pool path to which the branch ink pool paths for supplying ink to the ink chambers are commonly connected.

According to another aspect of the present invention, an ink jet recording head, which includes nozzles arranged in a line and column matrix, ink chambers provided correspondingly to the respective nozzles and pressuring ink filling therein, a plurality of branch ink pool paths provided along lines of the nozzles for supplying ink to the ink chambers, a main ink pool path to which the branch ink pool paths for supplying ink to the ink chambers are commonly connected and a pressure generating mechanism for generating pressure in ink in the ink chambers, is featured by that the ink chambers, the branch ink pool paths and the main ink pool path are formed in a crystalline plate and an ink supply port connected to the ink tank and a portion of an ink supply path from the ink supply port to the main ink pool path are formed on a material other than a material of the crystalline plate and connected together.

In this example, the ink chambers and the branch ink pool paths may be formed in a crystalline plate and the main ink pool path and the ink supply port connected to the ink tank through the ink supply path may be formed of a material other than a material of the crystalline plate and connected together.

By forming the main ink pool path and the ink supply port, which do not require high fabrication preciseness, of the material other than the material of the crystalline plate and connecting them to the ink chambers and the branch ink pool paths of the ink jet recording head, which are formed in the crystalline plate, it is possible to reduce an area of portions, which require high fabrication preciseness. Therefore, it is possible to increase an effective area of the crystalline plate to thereby reduce the fabrication cost of the ink jet recording head. Further, since it is possible to reduce an area of the ink jet recording head to be cut out by dicing, the freedom of arrangement of the ink jet recording heads on the crystalline plate is increased.

Further, the crystalline plate may be a crystalline silicon plate and the material other than silicon is preferably a material selected from a group consisting of synthetic resins and metals.

According to the present invention, the semiconductor fabrication process for processing silicon can be used and it is possible to use popular materials.

Further, the connection between the crystalline plate and the members formed of other material than the material of the crystalline plate can be done in on and the same plane or in different planes.

In the case where a plurality of ink jet recording heads are formed in the crystal plate by utilizing the semiconductor fabrication process, it is preferable in order to increase the number of ink jet recording heads formed in one wafer, to cut out a plurality of ink jet recording heads by dicing as a unit and to connect the preliminarily prepared main ink pool path and the ink supply port to the unit block by an adhesive. By doing so, it is possible to further increase the number of ink jet recording heads capable of being obtained from one wafer.

On the other hand, in fabricating ink jet recording heads for a multi color printer, it is preferable that at least ink jet recording heads for C, M and Y are formed by not individually but simultaneously in parallel on a wafer and cut out the three ink jet recording heads as a unit block. By fabricating the three ink jet recording heads simultaneously as the unit block by utilizing the semiconductor fabricating technology, there is no need of positional regulation for color matching and the color matching can be done with high precision.

That is, according to a second aspect of the present invention, a plurality of ink jet recording heads are formed on a crystalline plate as a plurality of unit blocks each including a pair of ink jet recording heads such that the two ink jet recording heads each having ink chambers arranged in a matrix are arranged on the crystalline plate with the ink chambers of one ink jet recording head opposing to the ink chambers of the other ink jet recording head.

A modification of this aspect is featured by that at least three ink jet recording heads each having ink chambers arranged in a matrix are arranged as a unit block, an intermediate ink jet recording head of each unit block has a main ink pool path commonly connected to the branch ink pool paths thereof formed on the crystalline plate and one of both side ink jet recording heads of each unit block have the matrix arranged branch ink chambers formed on the crystalline substrate and the other side ink jet recording head has the matrix arranged ink chambers formed on the crystalline substrate such that the matrix arranged ink chambers oppose to the matrix arranged ink chambers of the one side ink jet recording head.

According to another aspect of the present invention, a method for fabricating an ink jet recording head, which includes nozzles for jetting ink, ink chambers connected to the respective nozzles for pressurizing ink filling therein, an ink supply path for supplying ink to the ink chambers and a pressure generating mechanism for generating pressure in ink in the ink chambers, is featured by that the ink chambers and a portion of the ink supply path are formed in one crystalline substrate and the remaining portion of the ink supply path is formed of a material different from that of the crystalline substrate and connected to the portion thereof formed in the crystalline substrate.

A portion of the main ink pool path, to which the branch ink pool paths for supplying ink to the ink chambers are commonly connected, may be formed of the material different from that of the crystalline substrate and connected to the main ink pool path.

According to another aspect of the present invention, a method for fabricating an ink jet recording head, which includes a plurality of nozzles arranged in a line and column matrix, ink chambers provided correspondingly to the respective nozzles for pressurizing ink filling therein, a plurality of branch ink pools provided along the lines of the nozzles, for supplying ink to the ink chambers, a main ink pool path to which the branch ink pool paths are commonly connected and a pressure generating mechanism for generating pressure in ink in the ink chambers, is featured by that the ink chambers, the branch ink pool paths and the main ink pool path are formed in one crystalline substrate and an ink supply port connected to an ink supply path from an ink tank and a portion of the ink supply path from the ink supply port to the main ink pool path are formed of a material different from that of the crystal substrate and connected together.

Alternatively, it is possible to form the ink chambers and the branch ink pool paths in the crystalline plate and to form the main ink pool path, the ink supply port and the portion of the ink supply path from the ink supply port to the main ink pool path are formed of a material different from that of the crystalline substrate and connected together.

The crystalline plate may be a single crystal silicon substrate and the different material may be synthetic resin or metal.

Further, it is possible to form a pair of ink jet recording heads in the silicon substrate as a unit block with the matrix arranged ink chambers of one of the ink jet recording heads being in an opposing relation to the ink chambers of the other head and cut out the paired ink jet recording heads from the silicon substrate in block unit.

Alternatively, it is possible to form at least three of the ink jet recording heads in the silicon substrate as a unit block and cut out from the silicon substrate with the intermediate ink jet recording head of each unit blocks having the main ink pool path commonly connected to the branch ink pool paths thereof being formed in the silicon substrate and cut out the heads from the silicon substrate in block unit.

According to another aspect of the present invention, an assembling method for assembling an ink jet recording head formed in a crystalline plate with an auxiliary plate is featured by comprising the steps of forming a main ink pool path and an ink supply port for connecting an ink supply path, which is formed in the auxiliary plate formed of a synthetic resin or a metal, mounting the auxiliary plate on a base plate of the ink jet recording head, mounting a silicon head cut out from a silicon substrate formed with ink chambers and a portion of the ink supply path for supplying ink to the ink chambers in contact with the auxiliary plate, adhering the silicon head to the auxiliary plate, attaching a vibration plate provided with a pressure generating mechanism for generating pressure in ink filling the ink chambers and an electric wiring for driving the pressure generating mechanism to a back side of the silicon head and the auxiliary plate and connecting the ink supply path from the ink tank to the ink supply port.

According to another aspect of the present invention, a method for forming ink jet recording heads in a silicon substrate and cutting out the ink jet recording head from the silicon substrate is featured by comprising the steps of forming two ink jet recording heads each including nozzles for jetting ink droplets and ink chambers arranged in a line and column matrix and branch ink pool paths provided adjacent to the nozzles along the line direction, for supplying ink to the ink chambers, in the silicon substrate with the branch ink pool paths of one of the ink jet recording head being in an opposing relation to the branch ink pool paths of the other ink jet recording head, and cutting out the ink jet recording heads from the silicon substrate as a unit block.

Alternatively, the method for forming ink jet recording heads in a silicon substrate and cutting out the ink jet recording head from the silicon substrate is featured by comprising the steps of forming at least three of the ink jet recording heads each including nozzles for jetting ink droplets and ink chambers arranged in a line and column matrix and branch ink pool paths provided adjacent to the nozzles along the line direction, for supplying ink to the ink chambers, in the crystal substrate as a unit block, forming a main ink pool path of a center ink jet recording head of the at least three ink jet recording heads, to which the branch ink pool paths are commonly connected, in the silicon substrate and cutting out the ink jet recording heads from the silicon substrate in block unit.

### BRIEF DESCRIPTION OF THE DRAWINGS

Specific embodiments of the present invention will now be described, by way of example only, with reference to the accompanying of drawings in which:

FIG. 1 shows an example of an arrangement of ink jet recording heads according to a first embodiment of the present invention on a silicon wafer;

FIG. 2 is a disassembled perspective view of the ink jet recording head according to the first embodiment of the present invention, illustrating a structure thereof;

FIG. 3 is a cross section of a joining portion of the ink jet recording head according to the first embodiment of the present invention;

FIG. 4 is a perspective view of the joining portion of the ink jet recording head according to the first embodiment of the present invention;

FIG. 5 is a plan view of a silicon head portion and an auxiliary plate of an ink jet recording head according to a second embodiment of the present invention;

FIG. 6 is a disassembled perspective view of the ink jet recording head according to the second embodiment of the present invention, illustrating a structure thereof;

FIG. 7 is a perspective view of the joining portion of the ink jet recording head according to the second embodiment of the present invention;

FIG. 8 shows an example of an arrangement of ink jet recording heads according to a third embodiment of-the present invention on a silicon wafer;

FIG. 9 is a cross section of an ink jet recording head in which a silicon head portion and the ink supply paths are formed in different planes; and

FIG. 10 shows a conventional arrangement of ink jet recording heads on a silicon substrate.

### DETAILED DESCRIPTION OF THE PREFERRED EMBODIMENTS

First Embodiment

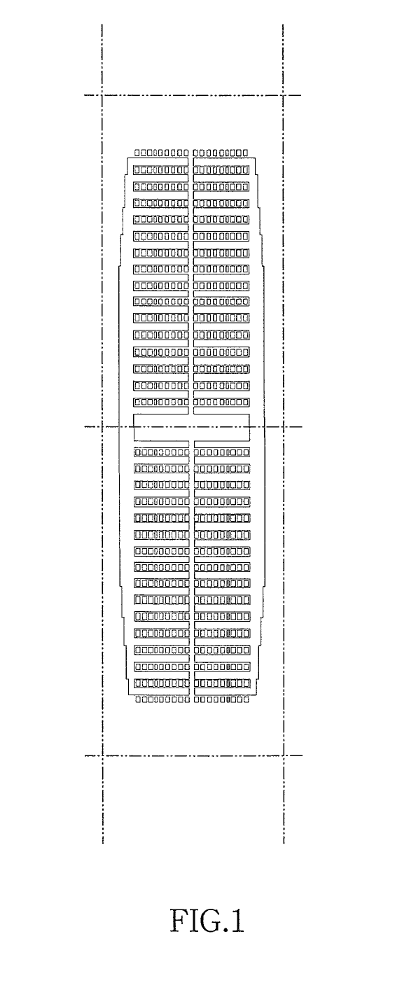

FIG. 1 shows an arrangement of a pair of ink jet recording heads formed in a silicon substrate according to an embodiment of the present invention in which each of the ink jet recording heads includes a plurality of nozzles and a plurality of ink chambers thereof are arranged in a matrix. The ink jet recording head shown in FIG. 1 includes the nozzles for jetting ink, which are provided in respective cross points of a plurality of lines and a plurality of columns of the matrix, the ink chambers provided correspondingly to the respective nozzles and pressurizing ink filling therein, a pressure generating mechanism for generating pressure in the ink chambers, a plurality of branch ink pool paths provided along the lines of the nozzles for supplying ink to the ink chambers and a main ink pool path connected to the branch ink pool paths, all of which are formed in a silicon substrate. The ink jet recording head is cut out from the silicon substrate. An ink supply port to be connected to a portion of an ink supply path connected to an ink tank and another portion of the ink supply path for connecting the ink supply port to the main ink pool path, which are separately formed of a different material from the material of the silicon substrate, are jointed to the ink jet recording head.

The paired ink jet recording heads constitute a rectangular unit block and the cutting process of ink jet recording heads is performed in block unit. In FIG. 1, the two ink jet recording heads are formed substantially symmetrically about a lateral center line of the rectangular block and the lines of the nozzles and the branch ink pool paths of each ink jet recording head are arranged in an interleaved relation. End portions of the nozzle lines of the two ink jet recording heads are close each other and the main ink pool paths thereof are formed on both sides of the rectangular block. Although only one unit block is shown in FIG. 1, at least 8 unit blocks can be arranged in a case of a 4-inch wafer.

In this embodiment, the block including two ink jet recording heads as a unit is cut out from the silicon substrate 1. Since, in this embodiment, the ink supply port for connecting a portion of an ink supply path from the ink tank and a portion of the ink supply path for connecting the ink supply port to the main ink pool path are not formed in the silicon substrate, it is possible to reduce a length of a longer side of the rectangular block and reduce an area of the silicon wafer occupied thereby correspondingly to the reduction of the side length. Further, since the paired ink jet recording heads, which are formed in the silicon substrate in a substantially symmetrical back to back matrix arrangement, are cut out from the silicon substrate as the unit block, it is possible to reduce the length of the shorter side of the rectangular ink jet recording heads compared with the case where a plurality of ink jet recording heads are formed in parallel in one direction and cut out from the silicon substrate one by one. As such, with the arrangement of the ink jet recording heads according to the first embodiment, it is possible to increase the number of ink jet recording heads, which can be formed in one wafer.

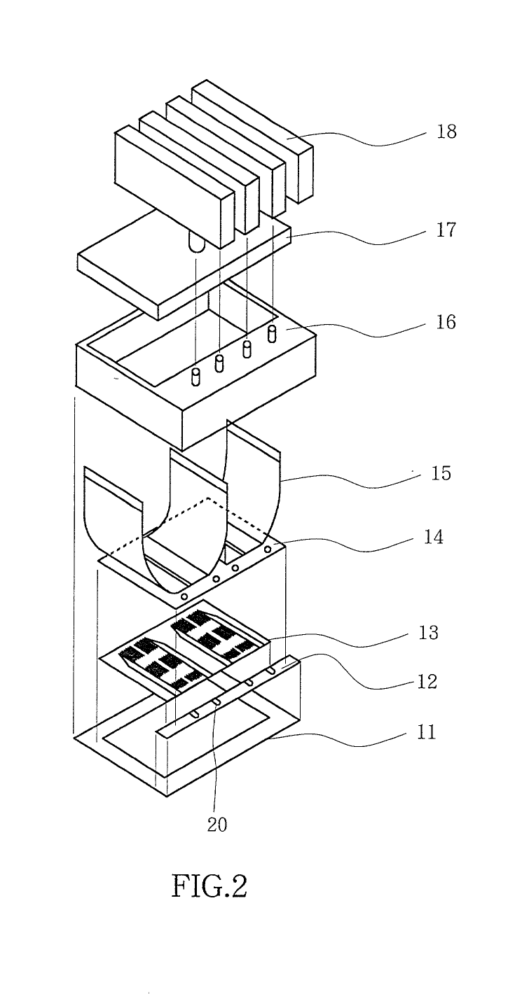

FIG. 2 is a disassembled perspective view of a printing head constructed with 2 unit blocks each including 2 ink jet recording heads arranged symmetrically about the lateral center line as shown in FIG. 1.

The printing head shown in FIG. 2 includes a base plate 11 formed of a metal or other material and adapted to face to a printing sheet and an auxiliary plate 12 adhered to the base plate 11 and connected to a silicon head portion 13 including the nozzles, the ink chambers and the ink pools, for completing the ink supply path from the ink tank 18, which reserves required color inks, to the base plate 11. In the auxiliary plate 12, the ink supply ports 20 to be connected to an ink supply path from the ink tank 18 and an ink supply path to the main ink pool path 21 are formed. The ink supply path from the ink tank 18 to the nozzles are completed by connecting the silicon head portion 13 to the auxiliary plate 12. A vibration plate 14 on which piezo electric elements are arranged correspondingly in position to the ink chambers is connected to the silicon head portion 13. Electric wiring 15 for driving the piezo electric elements on the vibrating plate 14 extends from the vibrating plate 14. The printing head is completed by fitting an ink supply path block 16 for supplying ink from the ink tank 18 to the auxiliary plate and mounting a cover 17 and the ink tank 18 thereon.

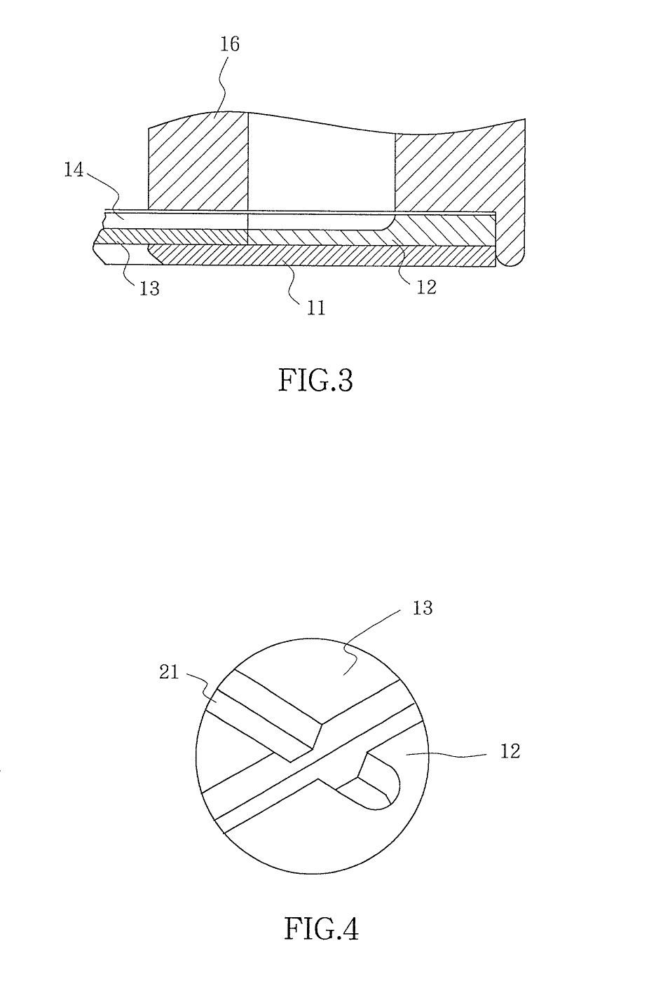

FIG. 3 is a cross sectional view of the ink jet recording head taken along a center line of the main ink pool path extending to the ink supply port 20, showing a relation between the base plate 11, the silicon head portion 13, the auxiliary plate 12 and the ink supply path block 16. In FIG. 3, the silicon head portion 13 and the auxiliary plate 12 are connected each other on an upper surface of the base plate 11.

FIG. 4 is a perspective view of the printing head, showing the connection between the main ink pool path 21 of the silicon head portion 13 and the ink supply port 20 of the auxiliary plate 12. The auxiliary plate 12 and the silicon head portion 13 have substantially the same thickness and are adhered to each other by an adhesive of silicon type or other type.

Second Embodiment

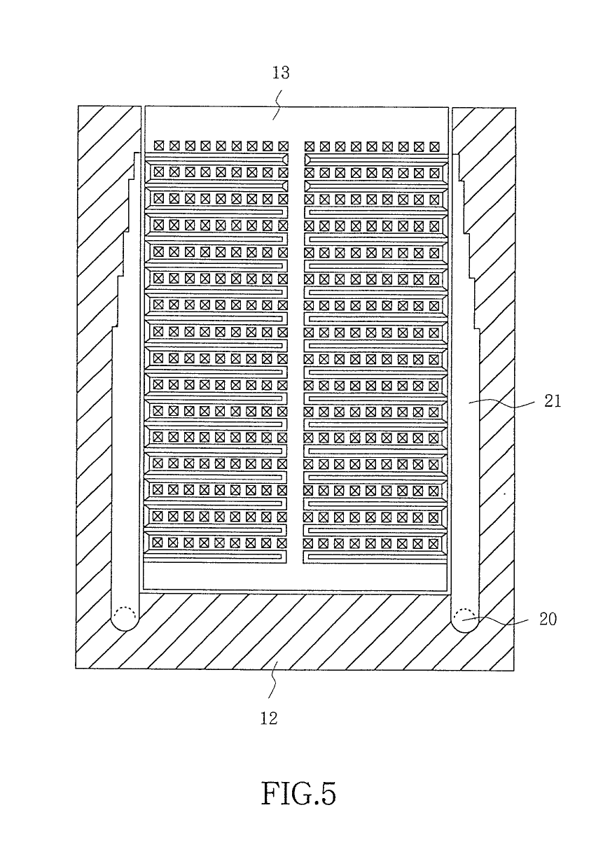

FIG. 5 is a plan view of an ink jet recording head according to a second embodiment of the present invention. In FIG. 5, a portion of the ink supply path of the ink jet recording head shown in FIG. 1, which extends from the ink tank to the main ink pool paths, is formed as a different part. In the second embodiment, a silicon head portion 13 composed of two silicon substrates each formed with matrix-arranged nozzles and ink chambers and the auxiliary plate formed with the main ink pool paths 21 and the ink supply ports 20 connected to the portion of the ink supply path to the ink tank 18 are bonded each other by an adhesive, etc. The silicon head portion 13 is cut out from the wafer by dicing along sides of the branch ink pool paths thereof facing to the respective main ink pool paths and bonded to the auxiliary plate 12 formed of the material different from the silicon material. Since, in the second embodiment, the main ink pool paths are not formed in the silicon substrate, it is possible to further reduce the length of the shorter side of the rectangular head, so that the area of the head portion of the ink jet recording head, which is formed of silicon, can be further reduced and the number of silicon head portions, which can be cut out from one wafer, can be increased.

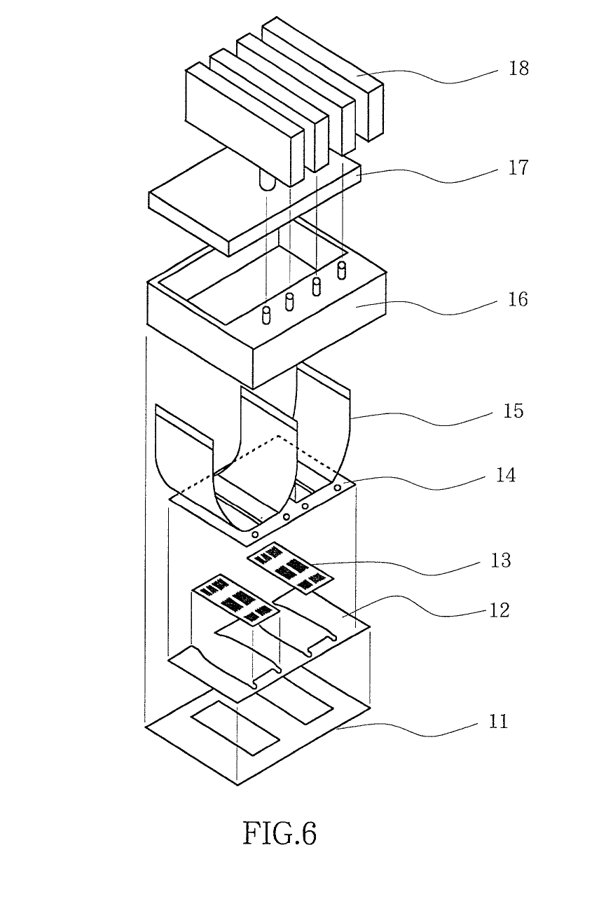

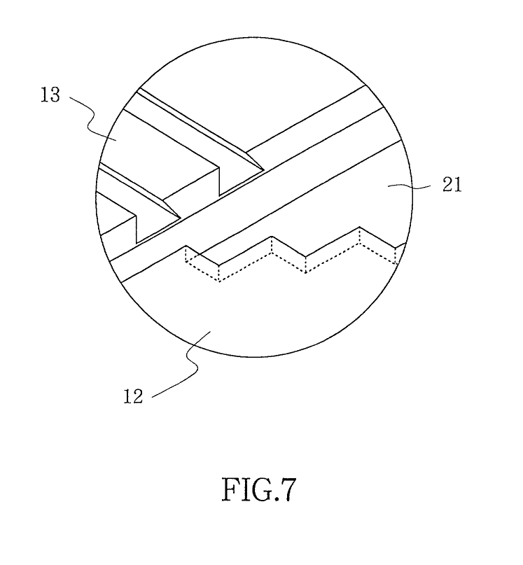

FIG. 6 is a disassembled perspective view of a printer head according to the second embodiment, which corresponds to the printer head shown in FIG. 2. In the second embodiment, since the auxiliary plate includes the main ink pool paths, an area occupied by the auxiliary plate becomes large and an area occupied by the silicon head portion is further reduced.

FIG. 7 is a perspective view of a portion of the ink jet recording head according to the second embodiment, showing a connecting relation of the branch ink pool path and the main ink pool path.

According to the second embodiment, the number of ink jet recording heads, which can be obtained from one wafer, can be increased compared with the first embodiment.

Third Embodiment

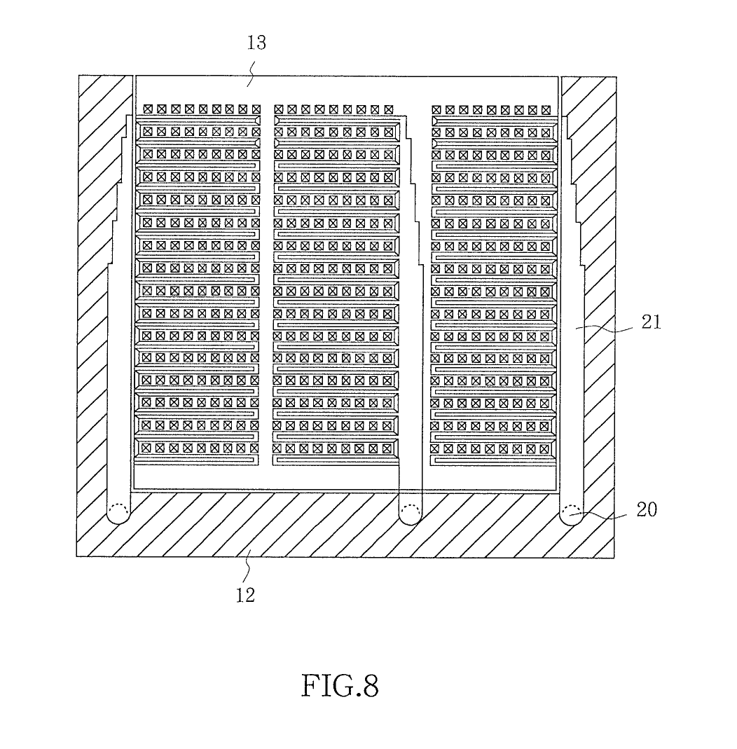

FIG. 8 is a plan view of an ink jet recording head according to a third embodiment of the present invention, in which three ink jet recording head portions are formed as a unit block and the ink jet recording heads are cut out from the substrate in block unit.

In the case of the color printing, it is necessary to use C, M and Y color inks and to regulate the positions of nozzles of the ink jet recording heads for jetting the respective three color inks highly accurately. Therefore, three ink jet recording heads for jetting respective C, M and Y inks are grouped as a unit printer head block and the printer heads are cut out from a wafer in printer head block unit.

In this case, in order to reduce an area of a portion formed of silicon to thereby increase the number of ink jet recording heads, which can be obtained from a wafer, it is preferable that ink supply paths including the main ink pool paths of outer two ink jet recording heads among the three ink jet recording heads of the unit block are formed of other material than silicon. In such case, since it is impossible to form the main ink pool path of the center ink jet recording head of a material other than silicon, the center ink jet recording head is formed in the silicon substrate together with nozzles, ink chambers and branch ink pool paths thereof. The ink supply port to be connected to the ink tank and the portion of the ink supply path to be connected to the main ink pool path thereof are formed of a material other than silicon and joined to the center ink jet recording head such that the ink supply path is formed, similarly to the outer side ink jet recording heads.

In the third embodiment, the three ink jet recording heads are formed simultaneously by photo etching step of a semiconductor fabrication process. Therefore, it is possible to precisely form the ink jet recording heads without positional deviation of the nozzles to thereby eliminate positional deviation of color inks in the multi color printing. Further, since there is no need of precisely positioning and assembling the three ink jet recording heads, the assembling step can be simplified.

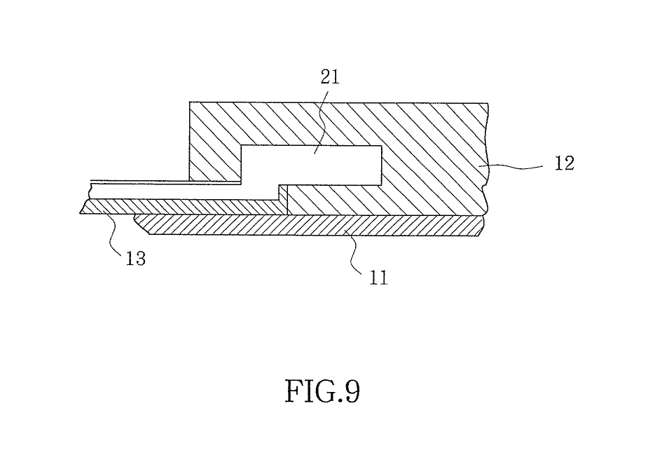

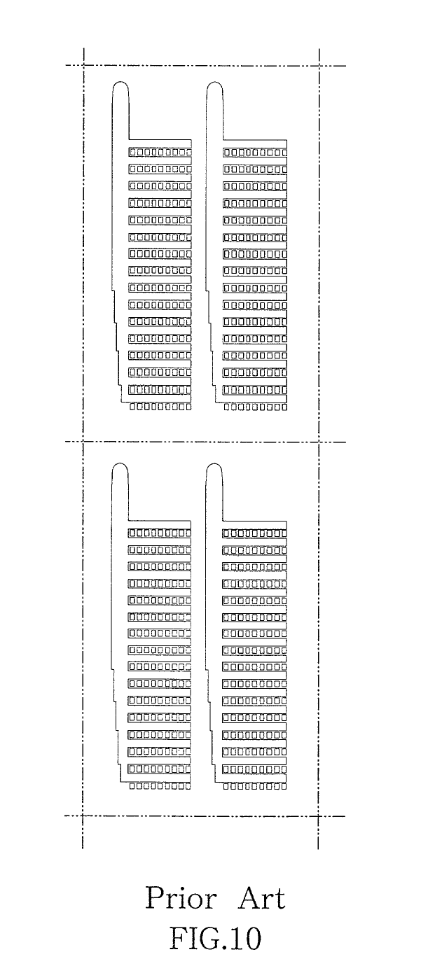

Although the auxiliary plate and the silicon head portion are connected together in the same plane in the first or second embodiment, it is possible to connect the auxiliary plate and the silicon head portion in different planes. For example, as shown in FIG. 9, it is possible to form the main ink pool path portion in a different level from the level of the branch ink pool paths and to connect the branch ink pool paths to the respective branch ink pool paths of the silicon head portion. Since the main ink pool path can be formed of other material than that of the silicon head portion and the freedom of the material selection is high, it is possible to design the main ink pool path such that flow of ink becomes more smooth. Further, since the silicon head portion is fitted in the auxiliary plate and bonded thereto with using adhesive, it is possible to design the main ink pool path with which ink flow becomes smooth.

Incidentally, the silicon head portions in the first, second and third embodiments have been described as having rectangular shapes in plan view with the nozzles and the ink chambers being arranged in line and column matrix. However, it is preferable practically to arrange the nozzles and the ink chambers matrix with the lines being slightly slanted toward the printing direction. With such matrix arrangement of the nozzles and ink chambers, it becomes possible to reduce the dot pitch in printing, so that a high density printing becomes possible. In such case, the whole ink jet recording head block formed in the silicon substrate becomes rectangular parallelepiped configuration. However, the effect of the increase in number of ink jet recording heads capable of being cut out from the silicon wafer is the same as that of the described embodiments.

Alternatively, the ink jet type recording head may be fabricated by forming the nozzles in, for example, a metal plate and sticking the metal plate and the silicon substrate formed with the ink chambers together.

As described, since, according to the present invention, it is possible to increase the number of ink jet recording heads capable of being cut out from the silicon substrate, the fabrication cost of ink jet recording head can be reduced. Further, since the number of ink jet recording heads to be formed on one wafer can be increased, the degradation of yield due to probably produced defect can be avoided, so that the fabrication cost thereof can be reduced.

Further, since a plurality of ink jet recording heads are formed in the silicon substrate as a unit block, it is possible to increase the number of ink jet recording heads capable of being cut out from the silicon wafer by arranging the unit blocks efficiently.

Further, in the multi color printing head, since at least three heads are formed as a unit bock, it is possible to avoid the degradation of printing quality due to positional error between heads. Further, the precise assembling of the multi color printing head can be easily achieved.

What is claimed is:

1. An ink jet recording head comprising a plurality of nozzles for jetting ink droplets, a plurality of ink chambers connected to respective said nozzles and pressurizing ink filling said ink chambers, an ink supply path for supplying ink to said ink chambers and a pressure generating mechanism for generating pressure within said ink chambers, wherein
at least said ink chambers and a portion of said ink supply path are formed in a crystalline substrate; and
the remaining portion of said ink supply path is formed of a material other than that of said crystalline substrate and connected to said portion of said ink supply path formed in said crystalline substrate.

2. An ink jet recording head as claimed in claim 1, wherein said remaining portion of said ink supply formed of said material other than that of said crystalline substrate is a main ink pool path to which branch ink pool paths for supplying ink to said ink chambers are commonly connected.

3. An ink jet recording head comprising:
a plurality of nozzles provided in a line and column matrix;
a corresponding number of ink chambers provided correspondingly to said nozzles and filled with ink to be pressurized;
a plurality of branch ink pool paths provided along said lines of said nozzles, for supplying ink to the plurality of said ink chambers;
a main ink pool path to which the plurality of said ink are commonly connected;
a pressure generating mechanism for generating pressure in said ink chambers,
wherein said ink chambers, said branch ink pool paths and said main ink pool path are formed in a crystalline substrate and an ink supply port connected to an ink supply path from an ink tank and an ink supply path from said ink supply port to said main ink pool path are formed of a material other than that of said crystalline substrate and connected to said main ink pool path.

4. An ink jet recording head comprising:
a plurality of nozzles arranged in a line and column matrix;
a corresponding number of ink chambers provided correspondingly to said nozzles and filled with ink to be pressurized;
a plurality of branch ink pool paths provided along said lines of said nozzles, for supplying ink to the plurality of said ink chambers;
a main ink pool path to which the plurality of said branch ink pool paths are commonly connected;
a pressure generating mechanism for generating pressure in said ink chambers,
wherein said ink chambers and said branch ink pool paths are formed in a crystalline substrate and said main ink pool path to which the plurality of said branch ink pool paths are connected and an ink supply port connected to an ink supply path from an ink tank are formed of a material other than that of said crystalline substrate and connected to said main ink pool path.

5. An ink jet recording head as claimed in claim 1, wherein said crystalline substrate is a crystalline silicon substrate and said material other than that of said crystalline substrate is selected from a group consisting of synthetic resins and metals.

6. An ink jet recording head as claimed in claim 3, wherein said crystalline substrate is a crystalline silicon substrate and said material other than that of said crystalline substrate is selected from a group consisting of synthetic resins and metals.

7. An ink jet recording head as claimed in claim 4, wherein said crystalline substrate is a crystalline silicon substrate and said material other than that of said crystalline substrate is selected from a group consisting of synthetic resins and metals.

8. An ink jet recording head as claimed in claim 1, wherein said remaining portion of said ink supply path formed of said material other than that of said crystalline substrate and said crystalline substrate are connected in a plane.

9. An ink jet recording head as claimed in claim 3, wherein said ink supply port and said ink supply path, which are formed of said material other than that of said crystalline substrate and said crystalline substrate are connected in a plane.

10. An ink jet recording head as claimed in claim 5, wherein said material other than that of said crystalline substrate and said crystalline substrate are connected in a plane.

11. An ink jet recording head as claimed in claim 1, wherein said remaining portion of said ink supply path formed of said material other than that of said crystalline substrate and said crystalline substrate are connected in different planes.

12. An ink jet recording head as claimed in claim 3, wherein said remaining portion of said ink supply path formed of said material other than that of said crystalline substrate and said crystalline substrate are connected in different planes.

13. An ink jet recording head as claimed in claim 5, wherein said remaining portion of said ink supply path formed of said material other than that of said crystalline substrate and said crystalline substrate are connected in different planes.

14. A crystal substrate formed with a plurality of ink jet recording heads each including a plurality of ink chambers arranged in a matrix as claimed in claim 4, wherein two of said ink jet recording heads are arranged as a unit block with branch ink pool paths of one of said two ink jet recording heads being in an opposing relation to branch ink pool paths of the other ink jet recording head, the plurality of said ink jet recording heads being cut out from said crystalline substrate in block unit.

15. A crystal substrate including nozzles arranged in a line and column matrix, a corresponding number of ink chambers provided correspondingly to said nozzles and filled with ink to be pressurized, a plurality of branch ink pool paths provided along said lines of said nozzles, for supplying ink to the plurality of said ink chambers, a main ink pool path to which the plurality of said ink are commonly connected and a pressure generating mechanism for generating pressure in said ink chambers, ink jet recording heads being cut out from said crystalline substrate,
wherein at least three ink jet recording heads are formed in said crystalline substrate as a unit block, said main ink pool path of a center ink jet recording head of said three ink jet recording heads is formed in said crystalline substrate and said nozzles and said ink chambers of said two ink jet recording heads on both sides of said center ink jet recording head are formed in said crystalline substrate such that said branch ink pool paths of one of said two ink jet recording heads being in an opposing relation to said branch ink pool paths of the other of said two ink jet recording heads.

16. A method for fabricating an ink jet recording head including nozzles for jetting ink droplets, ink chambers formed in communication with respective said nozzles, for pressurizing ink filling said ink chambers, an ink supply path for supplying ink to said ink chambers and a pressure generating mechanism, comprising the steps of:
forming said ink chambers and a portion of said ink supply path in a crystalline substrate; and
forming the remaining portion of said ink supply path of a material different from that of said crystalline substrate and connecting said remaining portion of said ink supply path to said portion of said ink supply path, formed in said crystalline substrate.

17. A method for fabricating an ink jet recording head, as claimed in claim 16, wherein a portion of said main ink pool path, to which said branch ink pool paths for supplying ink to said ink chambers are commonly connected, is formed of a material different from that of said crystalline substrate and connected to the remaining portion of said main ink pool path.

18. A method for fabricating an ink jet recording head including nozzles arranged in a line and column matrix, a corresponding number of ink chambers provided correspondingly to said nozzles and filled with ink to be pressurized, a plurality of branch ink pool paths provided along said lines of said nozzles, for supplying ink to the plurality of said ink chambers, a main ink pool path to which the plurality of said branch ink pool pahs are commonly connected and a pressure generating mechanism for generating pressure in said ink chambers, comprising the steps of:
forming said ink chambers, said branch ink pool paths and a portion of said main ink pool path in a crystalline substrate; and
forming an ink supply port connected to an ink supply path from an ink tank and an ink supply path from said ink supply port to said branch ink pool paths of a material different from that of said crystalline substrate and connecting said ink supply port and said passage to said crystalline substrate.

19. A method for fabricating an ink jet recording head including nozzles arranged in a line and column matrix, a corresponding number of ink chambers provided correspondingly to said nozzles and filled with ink to be pressurized, a plurality of branch ink pool paths provided along said lines of said nozzles, for supplying ink to the plurality of said ink chambers, a main ink pool path to which the plurality of said branch ink pool paths are commonly connected and a pressure generating mechanism for generating pressure in said ink chambers, comprising the steps of:
forming said ink chambers and said branch ink pool paths in a crystalline substrate; and
forming said main ink pool path and an ink supply port connected to an ink supply path from an ink tank of a material different from that of said crystalline substrate and connecting said main ink pool path and said ink supply port to said crystalline substrate.

20. A method for fabricating an ink jet recording head, as claimed in claim 16, wherein said crystalline substrate is a single crystalline silicon substrate and said material different from that of said crystalline substrate is a material selected from a group consisting of synthetic resins and metals.

21. A method for fabricating an ink jet recording head, as claimed in claim 18, wherein said crystalline substrate is a single crystalline silicon substrate and said material different from that of said crystalline substrate is a material selected from a group consisting of synthetic resins and metals.

22. A method for fabricating an ink jet recording head, as claimed in claim 19, wherein said crystalline substrate is a single crystalline silicon substrate and said material different from that of said crystalline substrate is a material selected from a group consisting of synthetic resins and metals.

23. A method for fabricating an ink jet recording head, as claimed in claim 18, wherein two of said ink jet recording heads each including said ink chambers arranged in a matrix are formed in said crystal substrate as a unit block with said branch ink pool paths of one of said ink jet recording heads being in an opposing relation to said branch ink pool paths of the other of said ink jet recording heads and said ink jet recording heads are cut out from said crystalline substrate in block unit.

24. A method for fabricating an ink jet recording head, as claimed in claim 19, wherein two of said ink jet recording heads each including said ink chambers arranged in a matrix are formed in said crystal substrate as a unit block with said branch ink pool paths of one of said ink jet recording heads being in an opposing relation to said branch ink pool paths of the other of said ink jet recording heads and said ink jet recording heads are cut out from said crystalline substrate in block unit.

25. A method for fabricating an ink jet recording head including nozzles arranged in a line and column matrix, a corresponding number of ink chambers provided correspondingly to said nozzles and filled with ink to be pressurized, a plurality of branch ink pool paths provided along said lines of said nozzles, for supplying ink to the plurality of said ink chambers, a main ink pool path to which the plurality of said ink are commonly connected and a pressure generating mechanism for generating pressure in said ink chambers, comprising the steps of:
forming at least three of said ink jet recording heads in a crystalline substrate as a unit block;
forming said main ink pool path of a center ink jet recording head of said at least three ink jet recording heads in said crystalline portion and said outer two ink jet recording heads in said crystalline substrate with said branch ink pool paths of one of said ink jet recording heads being in an opposing relation to said branch ink pool paths of the other of said ink jet recording heads; and
forming said main ink pool path of a material different from that of said crystalline substrate and connecting said main ink pool path to said crystalline substrate.

26. An assembling method of an ink jet recording head, comprising the steps of:
forming a main ink pool path and an ink supply port for connecting an ink supply path from an ink tank in an auxiliary plate formed of a synthetic resin or a metal;
mounting said auxiliary plate on a base plate of said ink jet recording head;
mounting a silicon head portion cut out from a silicon substrate formed with ink chambers and branch ink pool paths in contact with said auxiliary plate and adhering said silicon head to said auxiliary plate;
attaching a vibration plate provided with a pressure generating mechanism for generating pressure in ink filling said ink chambers and an electric wiring for driving said pressure generating mechanism to a back side of said silicon head portion and said auxiliary plate; and
connecting said ink supply path from said ink tank to said ink supply port.

27. An assembling method of an ink jet recording head, comprising the steps of:
forming a portion of an ink supply path in a auxiliary plate formed of a synthetic resin or a metal;
mounting said auxiliary plate on a base plate of said ink jet recording head;
mounting a silicon head portion cut out from a silicon substrate formed with ink chambers and a portion of an ink supply path for supplying ink to said ink chambers in contact with said auxiliary plate and adhering said silicon head portion to said auxiliary plate;
attaching a vibration plate provided with a pressure generating mechanism for generating pressure in ink filing said ink chambers and an electric wiring for driving said pressure generating mechanism to a back side of said silicon head portion and said auxiliary plate; and
connecting said ink passage from said ink tank to said ink supply port.
